(19) United States
(12) Patent Application Publication
(10) Pub. No.: US 2021/0346236 A1
(43) Pub. Date: Nov. 11, 2021

(54) STEAM FOOT MASSAGE MACHINE

(71) Applicant: Xiamen Emoka Health Science & Technology Co., Ltd., Xiamen (CN)

(72) Inventor: Guanghua ZHOU, Xiamen (CN)

(21) Appl. No.: 16/921,873

(22) Filed: Jul. 6, 2020

(30) Foreign Application Priority Data
May 6, 2020 (CN) 202020725191.9

(51) Int. Cl. A61H 15/02; A61H 15/00; A61H 35/00; A61H 33/06

(52) U.S. Cl. CPC A61H 15/02; A61H 15/0078; A61H 35/006; A61H 33/065; A61H 2205/12; A61H 2201/1671; A61H 2033/068; A61H 2201/0207; A61H 2201/1215; A61H 2201/1642; A61H 2015/0014

(57) ABSTRACT

The present disclosure discloses a steam foot massage machine, and relates to the technical field of massagers. The steam foot massage machine includes a housing, foot pads, a main body, a steam heating device, a movable connection assembly, massage devices and a rotation mechanism. The housing sleeves the outer part of the main body, the interior of the housing and the main body form a steam chamber, the interior of the main body forms a mounting chamber, the foot pads are arranged in the steam chamber, the massage devices are mounted on the foot pads, and the rotation mechanism is arranged below the foot pads and is in driving connection with the massage devices.

### CROSS-REFERENCE TO RELATED APPLICATIONS

This application claims the benefit of priority from Chinese Patent Application No. 202020725191.9, filed on May 6, 2020. The content of the aforementioned application, including any intervening amendments thereto, is incorporated herein by reference in its entirety.

### FIELD

The present disclosure relates to the technical field of massagers, and in particular to a steam foot massage machine.

### BACKGROUND

As living standards improve gradually, people's requirements on living quality also improve gradually, and particularly, people pay attention to health care. As a health care product, foot washing equipment has been widely favored by the mass because of its relaxing and comfortable massage effects. The current foot washing equipment mostly works by water bath, and massages acupuncture points of feet by hot or cold water to adjust body functions and achieve health care effects. However, water bath equipment has certain limitations, e.g., being susceptible to bacterial infections. Particularly, when using the water bath equipment in some public bath rooms, people are very susceptible to skin diseases. Besides, promotion of blood circulation by the water bath equipment is not excellent enough. However, steam fumigation can expand capillaries in fumigated parts and accelerate blood circulation, and thus is helpful to treat some diseases of the feet.

Although the existing steam massage basin can realize steam massage on soles of the feet, in actual use, the existing steam massage basin generates a small amount of steam, the temperature distribution in the basin is uneven, and user experience is bad. The steam of the steam massage basin needs to be blocked and reflected by the inner wall of the basin and then can fill the basin, and thus a lot of hot steam is consumed, the temperature is lowered, and the temperature distribution of the basin is not even. Besides, in order to avoid rapid dissipation of the steam, the existing steam massage basin is designed with a small opening for feet to stretch thereinto, which makes it more laborious for a user to put feet into the basin and thus also affects the user experience.

### SUMMARY

The main objective of the present disclosure is to overcome the shortcomings of an existing steam massage basin with a small amount of steam generated and uneven temperature distribution, and to provide a steam foot massage machine with a large amount of steam generated and uniform and stable temperature to improve user experience.

Another objective of the present disclosure is to overcome the defect existing in the prior art that the feet cannot be easily put into a steam massage basin, and to provide a steam foot massage machine which is convenient for the feet to stretch thereinto.

In order to achieve the above objectives, the present disclosure adopts the following technical solution:

a steam foot massage machine includes a housing, foot pads, a main body, a steam heating device, a movable connection assembly, massage devices and a rotation mechanism. The housing is provided with a movable upper cover and a fixed upper casing that sleeve the outer part of the main body, the housing and the movable upper cover cooperate to form a steam chamber, the main body is provided with a mounting chamber, the foot pads are arranged in the steam chamber, the massage devices are mounted on the foot pads, the rotation mechanism is arranged below the foot pads and is in driving connection with the massage devices, the steam heating device includes a steam heating assembly and an oscillator, the steam heating assembly is arranged in the mounting chamber, the oscillator is arranged on the steam heating assembly, a steam outlet of the steam heating device communicates with the steam chamber and faces the foot pads, and the movable upper cover is openably and closably arranged on the main body via the movable connection assembly.

The housing includes a lower casing, the fixed upper casing sleeves the lower casing, and the main body and the lower casing are connected to form the mounting chamber.

The rotation mechanism includes a motor, helical gears and long spur gears. The motor drives the helical gears to rotate, the helical gears drive the long spur gears to rotate, and the massage devices are assembled on rotational shafts of the long spur gears, so that cleaning of the massage devices is facilitated.

The motor is a double-output-shaft motor, the number of the helical gears is two, the number of the long spur gears is two, the number of the foot pads is two, the two foot pads are each provided with two rollers, two massage devices are arranged on the corresponding foot pads, the two helical gears are driven by the double-output-shaft motor and respectively drive the corresponding long spur gears to rotate, and the two long spur gears respectively drive the corresponding massage devices to rotate.

The massage devices include massage heads and massage beads, the massage beads are mounted on the massage heads, and the massage heads are connected with the rotation mechanism.

The steam heating assembly includes a water tank, a heating tank, a fan, an air guide hose and a water drainage tank. The water tank communicates with the heating tank, two ends of the air guide hose are respectively connected with the steam chamber and a steam outlet of the heating tank, the fan is arranged between the air guide hose and the steam chamber, a heating sheet is arranged in the heating tank, the oscillator is arranged in the heating tank, a power cord pressing plate is arranged on the oscillator, the outer side of the power cord pressing plate is provided with an oscillator sealing ring, and the water tank is connected with the water drainage tank via a water drainage rod.

The water tank includes a water tank upper casing, a water tank lower casing and a water tank plug. The water tank upper casing sleeves and covers the water tank lower casing, and the water tank plug is arranged at the bottom of the water tank lower casing.

The water tank communicates with the heating tank via a guiding tube and a rubber tube, one end of the rubber tube sleeves one end of the guiding tube, the other end of the rubber tube communicates with the heating tank, and the other end of the guiding tube communicates with the water tank.

The main body is provided with a touch panel, the touch panel is fixed to the main body by a panel support, and the part, corresponding to a mounting position of the water tank, of the upper end of the main body is provided with a manual control panel.

The movable connection assembly includes an upper cover fixing member, a fixing seat, a bolt, positioning teeth, positioning springs and a spring pressing plate. The bolt is horizontally inserted into the fixing seat, two ends of the bolt respectively pass through two ends of the upper cover fixing member, the fixing seat is connected with the upper cover fixing member via the bolt, the bottom of the fixing seat is fixed to the spring pressing plate, the number of the positioning springs is two, the two positioning springs are respectively fixed to two sides of the spring pressing plate, the positioning teeth sleeve and cover the tops of the positioning springs, and the upper cover fixing member connects the movable upper cover with the main body.

After adopting the above technical solution, the present disclosure achieves the following beneficial effects:

in the steam foot massage machine, the rotation mechanism drives the massage devices to rotate to massage feet, and cooperates with the steam heating device to heat the feet by steam. After the heating tank of the steam heating device heats water, the heated water is atomized by the oscillator. Under the action of the oscillator, more water mist is generated, so that the steam is diffused faster and can fill the steam chamber rapidly, and less hot steam is consumed. Thus the steam is distributed more uniformly and the temperature is more stable, thereby improving the user experience. The movable upper cover replaces the existing fixed upper cover, and is connected with the main body via the movable connection assembly, so that the upper cover can be opened to enable the feet to stretch into the steam foot massage machine conveniently.

### BRIEF DESCRIPTION OF THE DRAWINGS

In order to depict the technical solutions in the embodiments of the Description or in the prior art more clearly, the drawings to be used in depictions of the embodiments or the prior art will be depicted briefly hereinafter. It is apparent that the figures depicted hereinafter are merely some of the embodiments of the present disclosure. Those skilled in the art can further obtain other figures according to these figures without making creative labor.

FIG. 1 is a schematic diagram of an exploded structure of the present disclosure;

FIG. 2 is a schematic diagram of a structure of the present disclosure;

FIG. 3 is a diagram, in which a movable upper cover is in an open state, of the present disclosure; and

FIG. 4 is a top view of the present disclosure.

Notes to reference signs: housing 1, steam chamber 11, fixed upper casing 12, lower casing 13, foot pad 2, roller 21, main body 3, mounting chamber 31, touch panel 32, panel support 33, manual control panel 34, steam heating device 4, steam heating assembly 41, water tank 411, water tank upper casing 4111, water tank lower casing 4112, water tank plug 4113, water tank sealing ring 4114, water tank rubber plug 4115, heating tank 412, heating sheet 4121, fan 413, air guide hose 414, water drainage tank 415, water drainage rod 416, oscillator 42, power cord pressing plate 421, oscillator sealing ring 422, guiding tube 43, guiding tube sealing ring 431, rubber tube 44, movable upper cover 5, movable connection assembly 6, upper cover fixing member 61, fixing seat 62, bolt 63, positioning tooth 64, positioning spring 65, spring pressing plate 66, massage device 7, massage head 71, massage bead 72, rotation mechanism 8, motor 81, helical gear 82, and long spur gear 83.

### DETAILED DESCRIPTION OF THE EMBODIMENTS

In order to further interpret the technical solution of the present disclosure, the present disclosure will be depicted in detail by means of embodiments hereinafter.

In the depictions of the present disclosure, it needs to understand that, orientation or position relations indicated by the terms “center”, “longitudinal”, “lateral”, “upper”, “lower”, “front”, “back”, “left”, “right”, “vertical”, “horizontal”, “top”, “bottom”, “inner”, “outer” and the like are based on orientation or position relations shown in the Drawings, they merely serve to facilitate depicting the present disclosure and simplifying depictions rather than to indicate or suggest that the indicated devices or elements must have particular orientations and be configured and operated at the particular orientations, and thus cannot be understood as limiting the present disclosure. Unless otherwise indicated, the term “a plurality of” means two or more in the depictions of the present disclosure.

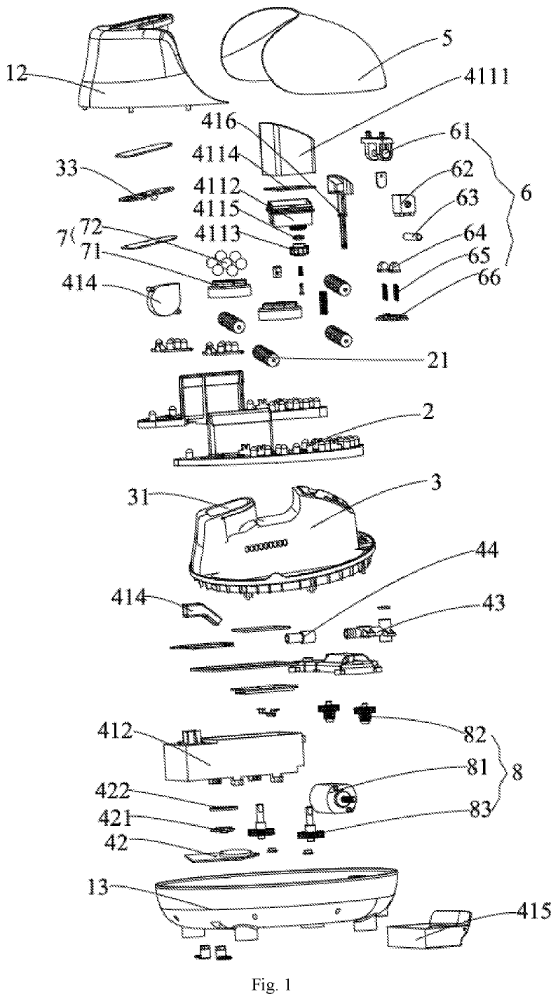

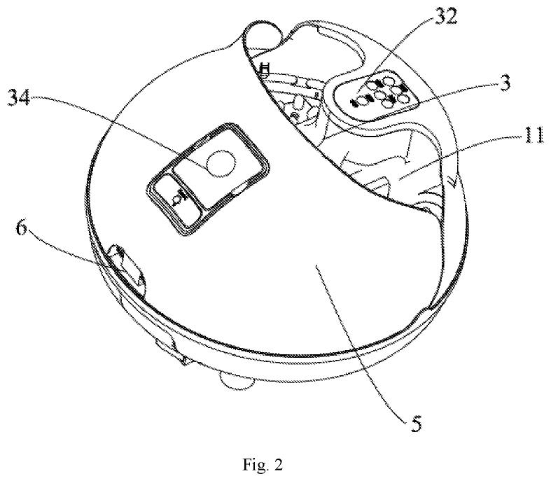

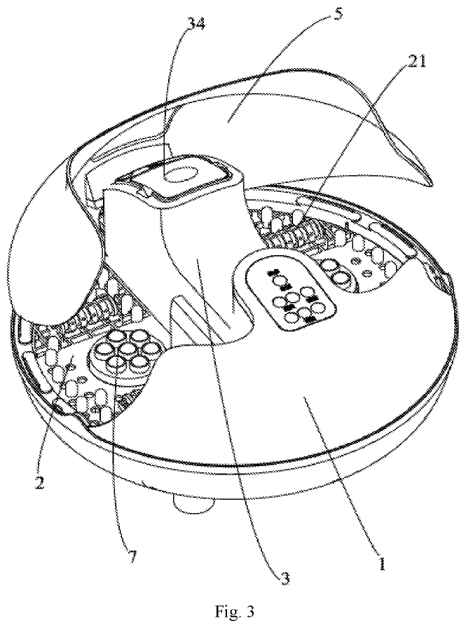

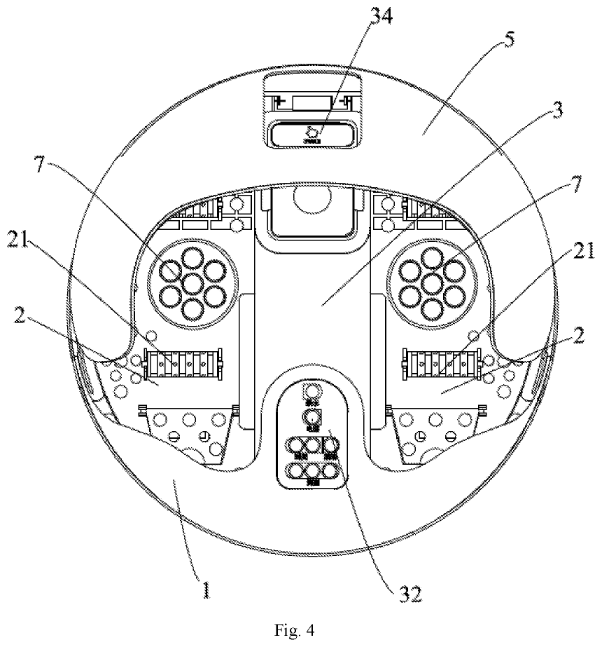

As shown in FIGS. 1-4, the present disclosure discloses a steam foot massage machine, which includes a housing 1, foot pads 2, a main body 3, a steam heating device 4, a movable connection assembly 6, massage devices 7 and a rotation mechanism 8.

The housing 1 is provided with a movable upper cover 5 and a fixed upper casing 12 that sleeve the outer part of the main body 3, and the housing 1 and the movable upper cover 5 cooperate to form a steam chamber 11. The housing 1 includes a lower casing 13, the fixed upper casing 12 sleeves the lower casing 13, and the main body 3 and the lower casing 12 are connected to form a mounting chamber 31.

The rotation mechanism 8 is arranged below the foot pads 2 and is in driving connection with the massage devices 7. The rotation mechanism 8 includes a motor 81, helical gears 82 and long spur gears 83. The motor 81 drives the helical gears 82 to rotate, and the helical gears 82 drive the long spur gears 83 to rotate, and the motor 81 is a double-output-shaft motor. Two helical gears 82, two long spur gears 83 and two foot pads 2 are symmetrically arranged on two sides of the main body 3, and the two foot pads 2 are each provided with two rollable rollers 21. Two massage devices 7 are arranged on the corresponding foot pads 2. The two helical gears 82 are correspondingly arranged on one side of two output shafts of the motor 81 and engage with the output shafts of the motor 81. The double-output-shaft motor drives the helical gears 82 to rotate, and the two helical gears 82 respectively engage with the two long spur gears 83 correspondingly to further drive the long spur gears 83 to rotate, rotational shafts of the two long spur gears 83 are respectively connected with the massage devices 7, and rotation of the long spur gears 83 can drive the corresponding massage devices 7 to rotate. The massage devices 7 include massage heads 71 and massage beads 72, the massage beads 71 are mounted on the massage heads 72, the massage heads 72 are connected with the rotational shafts of the long spur gears 83, and the massage devices 7 are assembled on the rotational shafts of the long spur gears, so that rotation of the massage heads 72 drives the massage beads 71 to rotate to achieve foot massage effects. The massage devices 7 are detachably assembled, so that cleaning of the massage devices 7 is facilitated.

The steam heating device 4 includes a steam heating assembly 41 and an oscillator 42, the steam heating assembly 41 is arranged in the mounting chamber 31, and the oscillator 42 is arranged on the steam heating assembly 41. A steam outlet of the steam heating device 4 communicates with the steam chamber 11 and faces the peripheries of the foot pads 2. The steam heating assembly 41 includes a water tank 411, a heating tank 412, a fan 413, an air guide hose 414 and a water drainage tank 415, the water tank 411 communicates with the heating tank 412, two ends of the air guide hose 414 respectively communicate with the steam chamber 11 and a steam outlet of the heating tank 412, the fan 413 is arranged between the air guide hose 414 and the steam chamber 11, a heating sheet 4121 is arranged in the heating tank 412, the oscillator 42 is arranged in the heating tank 412, a power cord pressing plate 421 is arranged on the oscillator 42, the outer side of the power cord pressing plate 421 is provided with an oscillator sealing ring 422, and the water tank 411 is connected with the water drainage tank 415 via a water drainage rod 416. The water tank 411 includes a water tank upper casing 4111, a water tank lower casing 4112 and a water tank plug 4113, the water tank upper casing 4111 sleeves and covers the water tank lower casing 4112, a water tank sealing ring 4114 sleeves the joint between the water tank upper casing 4111 and the water tank lower casing 4112, the water tank plug 4113 is arranged at the bottom of the water tank lower casing 4112, a water tank rubber plug 4115 is arranged at the joint between the water tank plug 4113 and the water tank lower casing 4112, the water tank sealing plug 4114 increases the sealability of the water tank 411, the water tank 411 communicates with the heating tank 412 via a guiding tube 43 and a rubber tube 44, one end of the rubber tube 44 sleeves one end of the guiding tube 43, the other end of the rubber tube 44 communicates with the heating tank 412, and the other end of the guiding tube 43 sleeves the water tank plug 4113, a guiding tube sealing ring 431 sleeves a connection of the guiding tube 43 and increases the sealability of the guiding tube 43, water in the water tank 411 flows through the guiding tube 43 and the rubber tube 44 into the heating tank 412 and is heated by the heating sheet 4121 in the heating tank 412, the heated water is atomized by the oscillator 42, and under the action of the fan 413, steam is blown towards the peripheries of the foot pads 2 via the air guide hose 414 and air outlets in the main body 3.

The main body 3 is provided with a touch panel 32, the touch panel 32 is fixed to the main body 3 by a panel support 33, and a manual control panel 34 is arranged at the part, corresponding to a mounting position of the water tank, of the upper end of the main body 3, and steam temperature, foot massage and the like of the steam foot massage machine are controlled by means of the touch panel 32.

The movable upper cover 5 is movably fixed to the main body 3 via the movable connection assembly 6. The movable connection assembly 6 includes an upper cover fixing member 61, a fixing seat 62, a bolt 63, positioning teeth 64, positioning springs 65 and a spring pressing plate 66. The bolt 63 is horizontally inserted into the fixing seat 62, two ends of the bolt 63 respectively pass through two ends of the upper cover fixing member 61, the fixing seat 62 is connected with the upper cover fixing member 61 via the bolt 63, and the bottom of the fixing seat 62 is fixed to the spring pressing plate 66. The number of the positioning springs 65 is two, the two positioning springs 65 are respectively fixed to two sides of the spring pressing plate 66, the positioning teeth 64 sleeve and cover the tops of the positioning springs 65, the upper cover fixing member 61 connects the movable upper cover 5 with the main body 3, the movable connection assembly 6 is rotatable around the bolt 63, and the movable upper cover 5 is movably fixed to the main body via the movable connection assembly 6, so that the movable upper cover 5 is rotatable around the bolt 63 and thus can be opened to enable feet to stretch into the steam foot massage machine conveniently.

The working principles of the present disclosure are as follows:

the movable upper cover 5 of the steam foot massage machine is movably fixed to the main body 3 of the steam foot massage machine via the movable connection assembly 6, and the movable connection assembly 6 is rotatable around the bolt 63 so that the movable upper cover 5 is rotatable around the bolt 63 and thus can be opened to enable feet to stretch into the steam foot massage machine conveniently. Water is heated by the heating assembly 41 in the steam heating device 4 and the heated water is then atomized by the oscillator 42, and thus more steam can be generated. Under the action of the fan 413, the steam is blown out from the air outlets in the main body 3 via the air guide hose 414 and rapidly fills the entire steam chamber 11. The steam is distributed relatively uniformly and the temperature is stabler, thereby improving user experience. Rotation of the rotation mechanism 8 drives the massages devices 7 to rotate, and the massage devices 7 rotate to achieve the function of massage.

In summary, the above depictions of the detailed embodiments are only to illustrate the technical solution of the present disclosure rather than to limit the scope of the present disclosure. Accordingly, without departing from the spirit and scope of the present disclosure, other modifications to the technical solution of the present disclosure or their equivalents shall fall into the scope of the present disclosure defined by the appended claims.

I claim:

1. A steam foot massage machine, comprising a housing, foot pads, a main body, a steam heating device, a movable connection assembly, massage devices and a rotation mechanism, wherein the housing is provided with a movable upper cover and a fixed upper casing that sleeve the outer part of the main body, the housing and the movable upper cover cooperate to form a steam chamber, the main body is provided with a mounting chamber, the foot pads are arranged in the steam chamber, the massage devices are mounted on the foot pads, the rotation mechanism is arranged below the foot pads and is in driving connection with the massage devices, the steam heating device comprises a steam heating assembly and an oscillator, the steam heating assembly is arranged in the mounting chamber, the oscillator is arranged on the steam heating assembly, a steam outlet of the steam heating device communicates with the steam chamber and faces the foot pads, and the movable upper cover is openably and closably arranged on the main body via the movable connection assembly.

2. The steam foot massage machine according to claim 1, wherein the housing comprises a lower casing, the fixed upper casing sleeves the lower casing, and the main body and the lower casing are connected to form the mounting chamber.

3. The steam foot massage machine according to claim 1, wherein the rotation mechanism comprises a motor, helical gears and long spur gears, the motor drives the helical gears to rotate, the helical gears drive the long spur gears to rotate, and the massage devices are detachably fixed to rotational shafts of the long spur gears.

4. The steam foot massage machine according to claim 3, wherein the motor is a double-output-shaft motor, the number of the helical gears is two, the number of the long spur gears is two, the number of the foot pads is two, the two foot pads are each provided with two rollers, two massage devices are arranged on the corresponding foot pads, the two helical gears are driven by the double-output-shaft motor and respectively drive the corresponding long spur gears to rotate, and the two long spur gears respectively drive the corresponding massage devices to rotate.

5. The steam foot massage machine according to claim 1, wherein the massage devices comprise massage heads and massage beads, the massage beads are mounted on the massage heads, and the massage heads are connected with the rotation mechanism.

6. The steam foot massage machine according to claim 1, wherein the steam heating assembly comprises a water tank, a heating tank, a fan, an air guide hose and a water drainage tank, the water tank communicates with the heating tank, two ends of the air guide hose are respectively connected with the steam chamber and a steam outlet of the heating tank, the fan is arranged between the air guide hose and the steam chamber, a heating sheet is arranged in the heating tank, the oscillator is arranged in the heating tank, a power cord pressing plate is arranged on the oscillator, the outer side of the power cord pressing plate is provided with an oscillator sealing ring, and the water tank is connected with the water drainage tank via a water drainage rod.

7. The steam foot massage machine according to claim 6, wherein the water tank comprises a water tank upper casing, a water tank lower casing and a water tank plug, the water tank upper casing sleeves the water tank lower casing, and the water tank plug is arranged at the bottom of the water tank lower casing.

8. The steam foot massage machine according to claim 6, wherein the water tank communicates with the heating tank via a guiding tube and a rubber tube, one end of the rubber tube sleeves one end of the guiding tube, the other end of the rubber tube communicates with the heating tank, and the other end of the guiding tube communicates with the water tank.

9. The steam foot massage machine according to claim 1, wherein the main body is provided with a touch panel, the touch panel is fixed to the main body by a panel support, and the part, corresponding to a mounting position of the water tank, of the upper end of the main body is provided with a manual control panel.

10. The steam foot massage machine according to claim 1, wherein the movable connection assembly comprises an upper cover fixing member, a fixing seat, a bolt, positioning teeth, positioning springs and a spring pressing plate, the bolt is horizontally inserted into the fixing seat, two ends of the bolt respectively pass through two ends of the upper cover fixing member, the fixing seat is connected with the upper cover fixing member via the bolt, the bottom of the fixing seat is fixed to the spring pressing plate, the number of the positioning springs is two, the two positioning springs are respectively fixed to two sides of the spring pressing plate, the positioning teeth sleeve and cover the tops of the positioning springs, and the upper cover fixing member connects the movable upper cover with the main body.
